(19) United States
(12) Patent Application Publication
(10) Pub. No.: US 2004/0264183 A1
(43) Pub. Date: Dec. 30, 2004

(54) Christmas lamp bulb

(76) Inventor: Chin-Chun Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/603,921

(22) Filed: Jun. 26, 2003

(51) Int. Cl. H01R 33/00

(52) U.S. Cl. 362/226; 362/806

(57) ABSTRACT

The invention provides a Christmas lamp bulb, including a lamp bulb, wherein the structure and shape of the wire lead terminal are in accordance with the inner hole of a conventional lamp socket; that is, the inner end of the wire lead terminal is a cylinder terminal with a shape of cylinder, whereas the outer end of the wire lead terminal is a rectangle terminal with a shape of rectangle. The Christmas lamp bulb of the invention is made by combining two different materials, glass and synthetic resin so that water can be prevented from permeating into the lamp bulb and the cost of material and labor for assembly can be lowered without changing the existing structure and external shape of the Christmas lamp bulb.

### BACKGROUND OF THE INVENTION

1. Field of the Invention

The invention relates to a lamp bulb and, more particularly, to a Christmas lamp bulb.

2. Description of the Related Art

A common Christmas lamp string is connecting a plurality of lamp sockets through a serial or parallel connection. A Christmas lamp bulb includes a lamp bulb and a lamp base, and a wire lead terminal of the lamp bulb is fixed by using the lamp base. Besides, the shape of the lamp socket is a cylinder, and two outer faces of one end of the lamp socket are leveled symmetrically. Also, the inner hole of the lamp socket is a stepped hole, which is a circular hole connected to a rectangle-shaped hole, whereas the corresponding end of the stepped hole to the outer-leveled end is a rectangle-shaped hole. Additionally, the other end of the lamp socket is a circular hole, and two conductive metal sheets are fixed symmetrically in the rectangle-shaped hole and separately connected to the power source wire. Moreover, the shape of the lamp base is in accordance with the inner hole of the lamp socket as a cylinder; that is, the inner terminal is a cylinder terminal, whereas the outer terminal is a rectangle terminal. Besides, a protruded ring is provided around the outer end of the cylinder terminal, whereas a stepped hole is provided as an inner hole, whose inner side is a circular shape but outer side is a rectangle shape. Besides, the corresponding end of the stepped hole to the outer-leveled end is a small rectangle-shaped hole, and a dividing bar is provided in the middle of the end portion of the small rectangle-shaped hole. The wire lead terminal of the lamp bulb usually is a cylinder in accordance with the inner circular hole of the lamp base, and the wire lead terminal can be inserted into the circular hole of the lamp base. In addition, two lead wires are leading out from the small rectangle-shaped hole of the lamp base and are separately bent in opposite directions to be attached to the symmetric faces of the leveled ends at the outer side of the lamp base. Moreover, the whole Christmas lamp bulb is composed of a lamp bulb and a lamp base, and the lamp bulb of the Christmas lamp bulb is made of glass, whereas the lamp base and lamp socket are made of synthetic resin.

To be conducted, the Christmas lamp bulb should be inserted into the lamp socket, and the lead wires at two sides of the lamp base will contact the conductive metal sheet inside the lamp socket so that the power source wires can be conducted. In addition, the accordance made between the lamp bulb and the lamp base is to wrap the lamp bulb by using the lamp base. However, such accordance is not very secure and reliable because water may permeate into the conjoining portion between the lamp bulb and the lamp base and in turn may result in a short circuit. Besides, the lamp bulb and lamp base are liable to become loosened. In particular, when replacing a lamp bulb is needed, the lamp base and lamp bulb are supposed to be plugged out together from the lamp socket; however, it often turns out that the lamp bulb is the only one being pulled out from the lamp base. More importantly, the cost of labor for assembling the lamp bulb and lamp base is high because a conventional Christmas lamp bulb always includes a lamp base as its component.

### SUMMARY OF THE INVENTION

The object of the invention is to provide a Christmas lamp bulb that can be closely inserted into and contact its lamp socket without a lamp base and without changing the existing structure of the lamp socket so as to prevent water from permeating into the lamp bulb as well as to save material cost and cost of labor for assembly.

To achieve the aforementioned object, the Christmas lamp bulb of the invention includes a lamp bulb, wherein the structure of the wire lead terminal of the lamp bulb is in accordance with the inner hole of the lamp socket; that is, the inner end of the wire lead terminal is a cylinder terminal, whereas the outer end of the wire lead terminal is a rectangle terminal; besides, the two lead wires are leading out from the end portion of the rectangle terminal, and they are bent separately in opposite directions to be attached to the two symmetrical side faces of the rectangle terminal.

Based on the above-mentioned design, the invention further includes:

1) a protruded ring that is provided around the outer end portion of the cylinder terminal.

2) a plurality of protruded bars in an axial direction that is distributed uniformly at the outer end of the cylinder terminal.

The benefits of the invention are described as follows. First, because the lamp bulb can do without a lamp base, water such as raindrops can be prevented from permeating into the lamp base as well as the lamp base can be prevented from loosening. Second, the lamp bulb can be closely inserted into and contact the lamp socket without changing the structure of existing lamp socket; therefore, the material cost and labor assembly cost can both be reduced. Third, because a protruded ring is provided along the outer portion of the leading terminal of the lamp bulb covering the plug-in holes of the lamp socket, it can effectively prevent water from permeating in.

### BRIEF DESCRIPTION OF THE DRAWINGS

FIG. 1 is a sectional schematic diagram showing the structure of a conventional Christmas lamp bulb.

FIG. 2 is a sectional schematic diagram showing a conventional Christmas lamp bulb is plugged into the lamp socket.

FIG. 3 is a sectional schematic diagram showing the structure of lamp base of a conventional Christmas lamp bulb.

FIG. 4 is a sectional schematic diagram showing the structure of a conventional Christmas lamp bulb.

FIG. 5 is a sectional schematic diagram showing the structure of the Christmas lamp bulb of the invention.

FIG. 6 is a schematic diagram showing the Christmas lamp bulb of the invention is plugged into the lamp socket.

FIG. 7 is a schematic diagram showing the structure of the Christmas lamp bulb of the invention.

FIG. 8 is a left-hand view of FIG. 7.

FIG. 9 is sectional schematic diagram showing another structure of the Christmas lamp bulb of the invention.

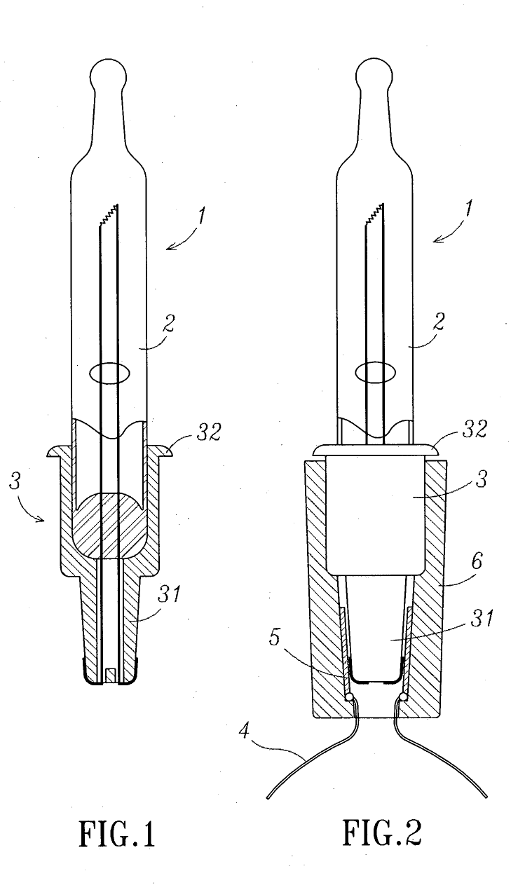

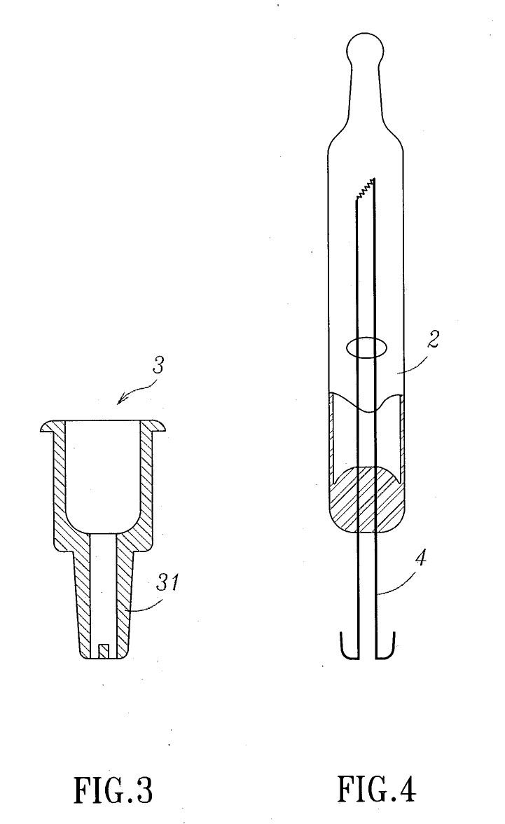

### DETAILED DESCRIPTION OF THE PREFERRED EMBODIMENTS

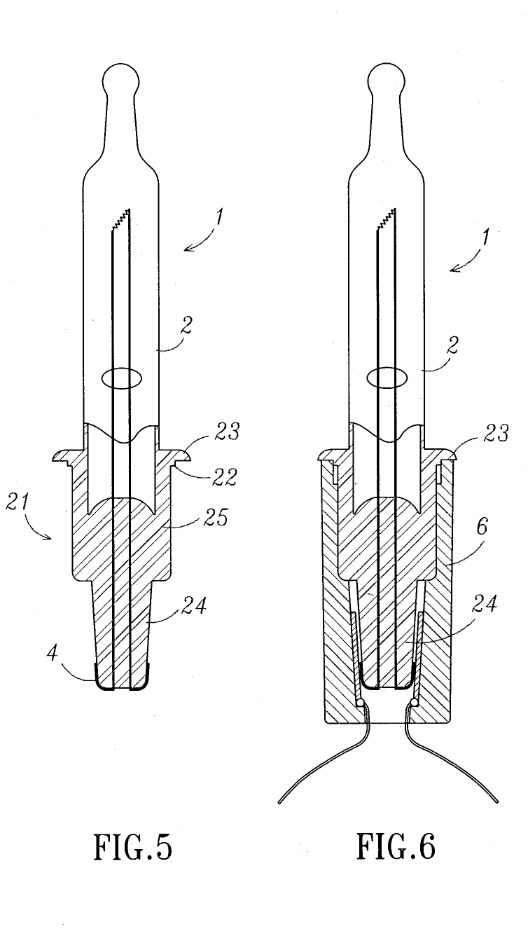

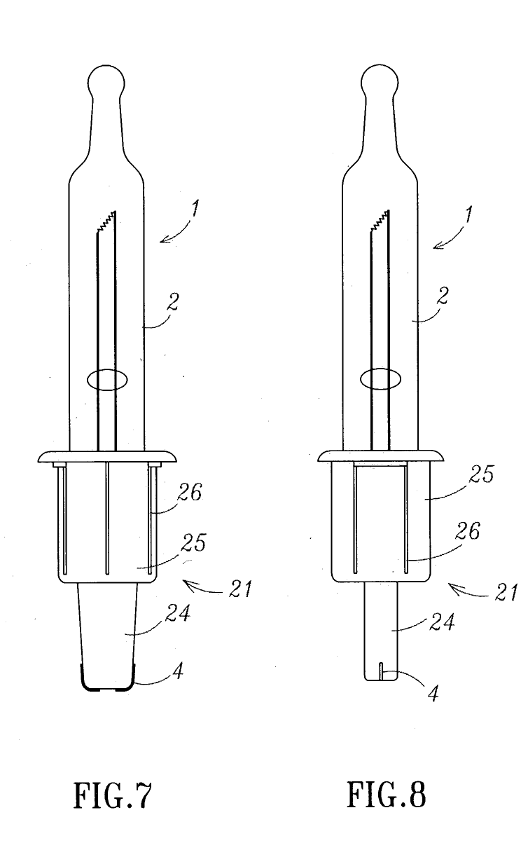

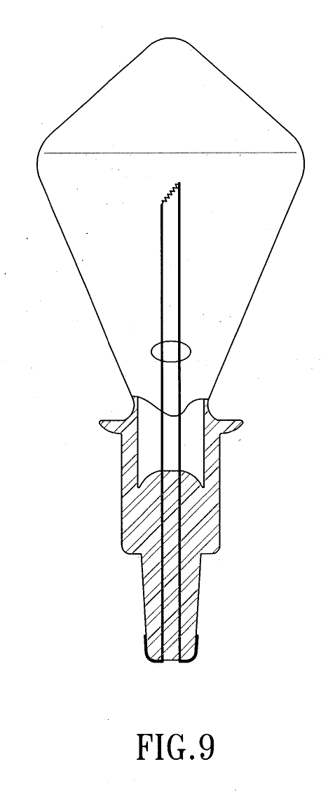

Referring to FIGS. 5, 6 & 7, the Christmas lamp bulb of the invention includes a lamp bulb, wherein the structure and shape of the wire lead terminal are in accordance with the inner hole of a conventional lamp socket 6; that is, the inner end of the wire lead terminal is a cylinder terminal 25 with a shape of cylinder, whereas the outer end of the wire lead terminal is a rectangle terminal 24 with a shape of rectangle. Besides, a protruded ring 23 is provided around the outer end portion of the cylinder terminal, and the lower end of the protruded ring 23 is equal to or larger than the perimeter of the lamp socket. Also, two lead wires 4 are leading out from the rectangle terminal 24, and they are bent separately in opposite directions to be attached to the two outer faces of the rectangle terminal 24. In addition, a plurality of protruded bars 26 in an axial direction is distributed uniformly at the outer end portion of the cylinder terminal 25.

The Christmas lamp bulb of the invention is made by combining two different materials, glass and synthetic resin, which are used for making conventional lamp bulb and lamp base respectively, to integrally form a glass lamp bulb without a lamp base so that the cost of material and labor for assembly can be lowered without changing the existing structure and external shape of the Christmas lamp bulb. Therefore, the lamp bulb can be closely inserted into and contact the lamp socket. Moreover, because a protruded ring is provided along the outer portion of the leading terminal of the lamp bulb covering the plug-in holes of lamp socket, it can effectively prevent water from permeating in.

What is claimed is:

1. A Christmas lamp bulb, including a lamp bulb, wherein the structure and shape of the wire lead terminal of the lamp bulb are in accordance with the inner hole of the lamp socket; that is, the inner end of the wire lead terminal is a cylinder terminal with a shape of cylinder, whereas the outer end of the wire lead terminal is a rectangle terminal with a shape of rectangle; besides, two lead wires are leading out from the rectangle terminal, and they are bent separately in opposite directions to be attached to the two outer symmetric faces of the rectangle terminal.

2. The Christmas lamp bulb as claimed in claim 1, wherein a protruded ring is provided at the outer end of the cylinder column.

3. The Christmas lamp bulb as claimed in claim 1, wherein a plurality of protruded bars in an axial direction is distributed uniformly at the outer end of the cylinder terminal.
